(19) United States
(12) Patent Application Publication
(10) Pub. No.: US 2007/0051528 A1
(43) Pub. Date: Mar. 8, 2007

(54) Novel decorative cover plates

(76) Inventor: Brian D. Bangert, Covina, CA (US)

Correspondence Address: JOSEPH E. MUETH, ESQ.;JOSEPH E. MUETH LAW CORPORATION, 8TH FLOOR, 225 S. LAKE AVENUE, PASADENA, CA, 91101, US

(21) Appl. No.: 11/361,876

(22) Filed: Feb. 24, 2006

Related U.S. Application Data
(60) Provisional application No. 60/656,603, filed on Feb. 25, 2005.
(60) Provisional application No. 60/679,781, filed on May 10, 2005.

(51) Int. Cl. H02G 3/14

(52) U.S. Cl. 174/66

(57) ABSTRACT

An assembly for covering the receptacle head of a receptacle containing a wall-mounted, button-operated GFI electrical outlet, comprising a cover plate having a front side and a rear side; a plurality of blade apertures extending through the cover plate through the front and back surfaces and positioned in the cover plate so the blade apertures are in substantial alignment with the blade apertures of at least one socket of an electrical outlet when the cover plate is affixed to the electrical outlet for receiving the plug blades; at least one securing aperture extending through the cover plate through the front the improvement wherein the cover plate has a pair of access openings to permit access to GFI buttons, the access openings being further adapted to be closed by inserts when GFI buttons are not present.

This patent claims the filing date of U.S. Provisional Patent Application Ser. No. 60/656,603, filed Feb. 25, 2005 and the filing date of U.S. Provisional Patent Application Ser. No. 60/679,781, filed May 10, 2005, the disclosures of which are incorporated herein by reference.

### BACKGROUND OF INVENTION

Various wall plate covers which are adapted to provide a decorative appearance have been proposed. For example, U.S. Pat. No. 5,375,728 to West, U.S. Pat. No. 5,965,846 Shotey et al, and U.S. Pat. No. 6,160,219 to Maltby et al. However, many standard plug-in type electrical outlets for installation in a wall recess for flush mounting now incorporate a ground fault interrupter (GFI). Typically, ground fault interrupters are button activating and re-setting. We have found that an access opening or openings in a cover plate should be provided which has minimal or no adverse effect on the aesthetic appearance. The present invention provides such cover plates.

### SUMMARY OF INVENTION

An assembly for covering the receptacle head of a receptacle containing a wall-mounted, button-operated GFI electrical outlet, comprising

a cover plate having a front side and a rear side;

a plurality of blade apertures extending through the cover plate through the front and back surfaces and positioned in the cover plate so the blade apertures are in substantial alignment with the blade apertures of the at least one socket of said electrical outlet when the cover plate is affixed to the electrical outlet for receiving the plug blades; and

at least one securing aperture extending through the cover plate through the front and back surfaces and positioned in the cover plate so the at least one securing aperture is in substantial alignment with a corresponding one of the at least one securing aperture of the electrical outlet when the cover plate is affixed to the electrical outlet for receiving the securing device and fixedly positioning the cover plate with respect to the electrical outlet, the cover plate being sized to cover the receptacle when the securing device is in place, the cover plate having peripheral edges which are adapted to abut the wall surfaces surrounding said wall mounted receptacle containing a GFI electrical outlet;

the improvement wherein the cover plate has a pair of access openings to permit access to GFI buttons, said access openings being further adapted to be closed by inserts when GFI buttons are not present.

An assembly for covering the receptacle head of a receptacle containing a wall-mounted, button operated GFI electrical outlet, comprising:

a cover plate having a front side and a rear side;

a plurality of non-electrically conductive prongs, mounted to and extending perpendicularly from the rear side of the cover plate sized and spaced to engage the blade receiving apertures of the electrical outlet;

the cover plate being sized to cover the receptacle when the prongs engage the blade receiving apertures of the electrical outlet; the cover plate having peripheral edges which are adapted to abut the wall surfaces surrounding said wall mounted GFI electrical outlet;

the improvement wherein said cover plate is scored on its rear surface to provide a weakened line defining a closed area which is adapted to be broken out and removed to provide access to the GFI buttons.

### DESCRIPTION OF PREFERRED EMBODIMENTS

In the drawings:

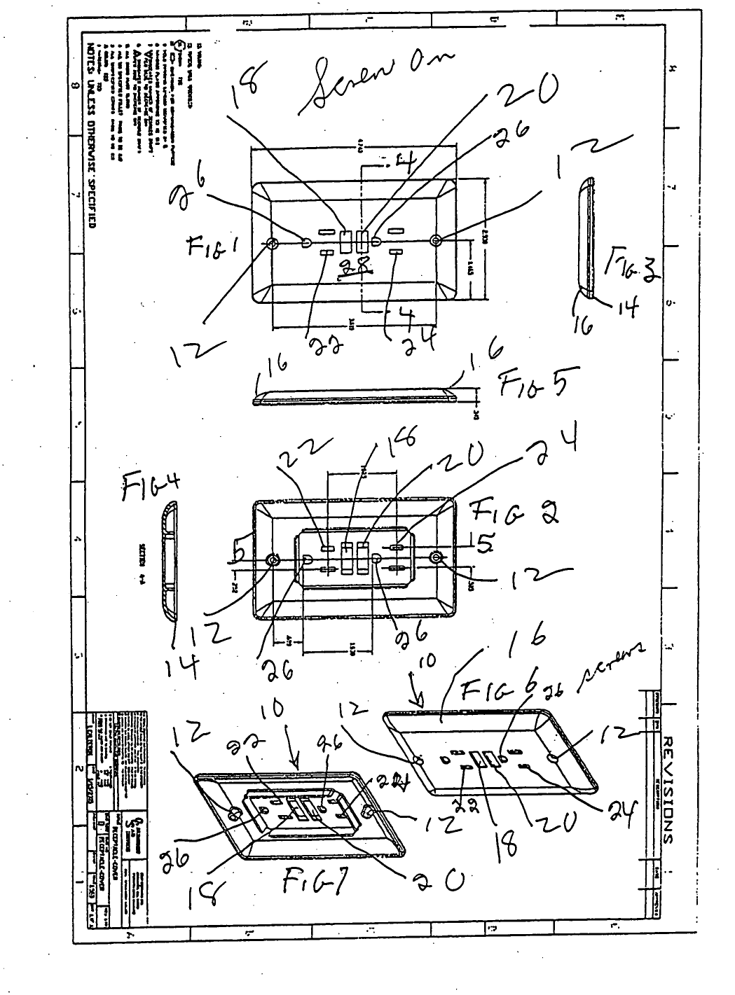

FIG. 1 is a front view of one embodiment of the cover plate of this invention.

FIG. 2 is a rear view of the embodiment of FIG. 1.

FIG. 3 is an end view of the embodiment of FIG. 1.

FIG. 4 is a sectional view taken along line 4-4 in FIG. 1.

FIG. 5 is a sectional view taken along line 5-5 in FIG. 2.

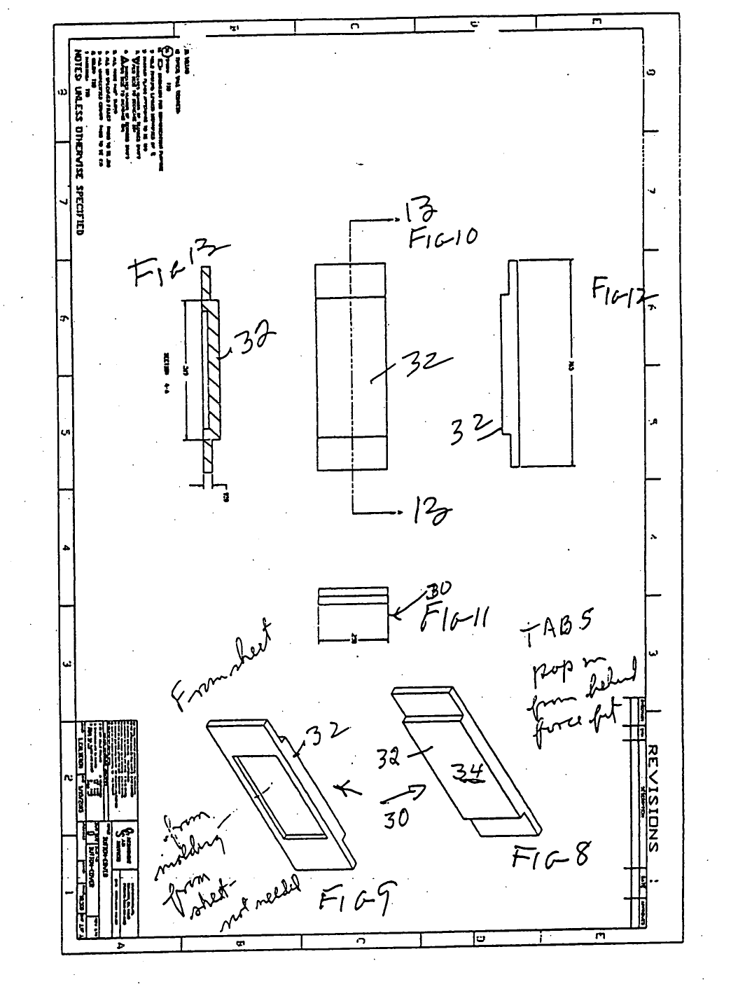

FIG. 6 is a front view, in perspective, of the embodiment of FIG. 1.

FIG. 7 is a rear view, in perspective, of the embodiment of FIG. 1.

FIG. 8 is a greatly enlarged view of the snap-in button opening insert, in front perspective view.

FIG. 9 is a greatly enlarged view of the snap-in button opening insert in rear perspective view.

FIG. 10 is a rear view of the snap-in button opening insert.

FIG. 11 is an end view of the insert of FIGS. 8-10.

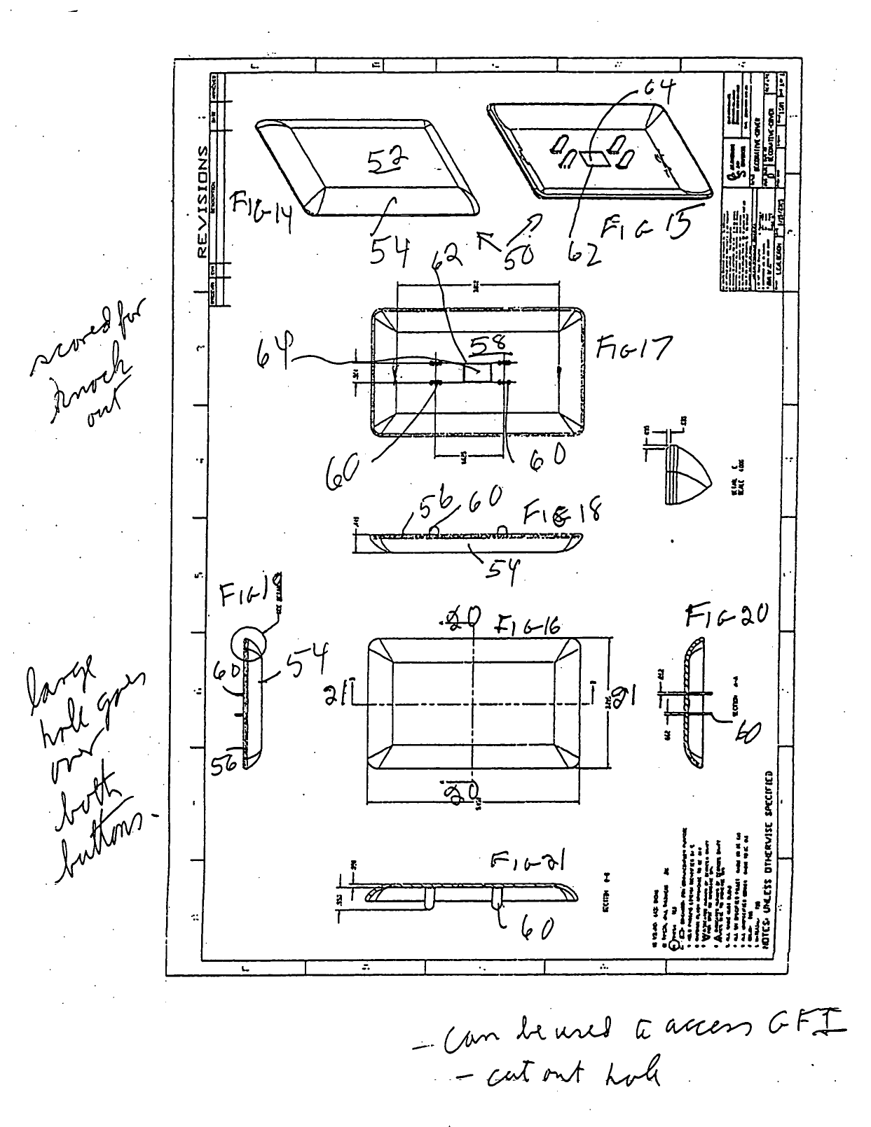

FIG. 12 is a side view of the insert of FIGS. 8-11.

FIG. 13 is a section view taken along line 13-13 in FIG. 10.

FIG. 14 is a front perspective view of another embodiment of a cover plate according to this invention.

FIG. 15 is a rear perspective view of the cover plate of FIG. 14.

FIG. 16 is a front plane view of the cover plate of FIGS. 14 and 15.

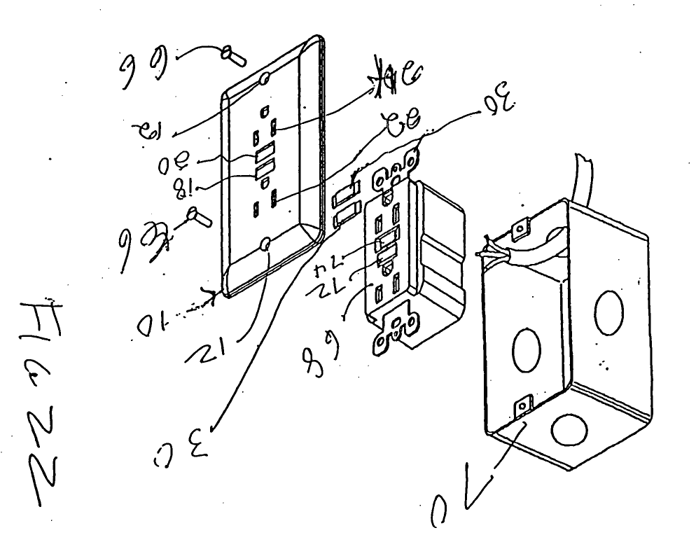

FIG. 17 is a rear plane view of the cover plate of FIGS. 14-16.

FIG. 18 is a side view of the plate cover of FIGS. 14-17.

FIG. 19 is an end view of the plate cover of FIGS. 14-18.

FIG. 20 is a sectional view taken along line 20-20 in FIG. 16.

FIG. 21 is a sectional view taken along line 21-21 in FIG. 16.

FIG. 22 is an exploded view of the cover plate of FIGS. 1 to 7 showing assembly with an electrical outlet and receptacle box.

Turning to the drawings in greater detail, the cover plate of FIGS. 1 to 13 is adapted to be screwed onto a wall outlet provided with a ground fault interrupter.

The electrical outlet has at least one socket and at least one screw-receiving opening. As can be seen, the embodiments shown in the FIGS. 1 to 13 and 22 of the drawings are for an electrical outlet which includes two sockets and two screw-receiving openings.

The cover plate, generally 10, has the two mounting screw apertures 12. The cover plate 10 is held to the electrical outlet which is normally received in a recess in a receptacle box in the wall so that the edges 14 of the curved side extremities 16 snugly abut the surface of the wall surrounding the recess.

The plate 10 is intended to go over an electrical outlet having a ground fault interrupter equipped with two buttons, the top button is the re-set button and the lower button pops or projects out when the ground fault interrupter is tripped by a short or surge in the electrical circuitry.

The cover plate 10 has two button receiving openings 18-20 therein.

The cover plate has two pairs of blade apertures 22 and 24. Each pair of blade apertures additionally has a third or ground plug aperture 26. The blade apertures are aligned with corresponding three blade receiving apertures in the sockets included in the wall electrical outlet to be able to receive standard 3 prong plugs from an electrical appliance. The outer exposed surfaces 28 of the cover plate may be provided with a variety of decorative finishes and treatments, usually to harmonize with the wall treatment of the back splash of a kitchen wall. Preferably, the outer exposed surfaces 28 have a granite or tile finish in any desired color.

Considering FIGS. 8-13 in more detail, the inserts 30 are shown in greatly enlarged scale. The inserts 30 are sized so that raised portion 32 snaps into each of the button receiving openings 18 and 20 from the rear of the openings with a slight interference fit. When the inserts 30 are in place in the button receiving openings 18 and 20, the front surface 34 of raised portion 32 is flush with the surrounding surface 28 of cover plate 10. A decorative finish can be applied over surface 28 and front surface 34 which effectively conceals the fine gaps between the edges of inserts 30 and the edges of openings 18 and 20. Thus, the invention is adapted to either exposed or concealed ground fault interrupter buttons.

The inserts 30 are typically made from a flat plastic sheet material which are heat formed into the final shape of the insert shown in FIGS. 8-13. With the inserts 30 in place, the buttons of the ground fault interrupter are covered up and concealed from view, an effect which is desirable from an aesthetic point of view is achieved.

The cover plate 10 is normally a single formed or molded plastic piece.

Turning to the alternate embodiment of FIGS. 14-21, the cover plate 50 has a smooth planar front surface 52, with curved marginal surfaces 54 and edges 56 which are intended to snugly abut the wall surface surrounding a recess in the wall for receiving a standard electrical outlet and receptacle. The outlet normally contains two sockets. The rear surface 58 of cover plate 50 contains two pairs of non-electrically conductive prongs 60. The prongs 60 are aligned with the corresponding blade receiving apertures in the sockets of the electrical outlet.

The prongs 60 thus hold the cover plate 50 in place and conceal the recess as well as the receptacle with outlet received within the recess.

The cover plate 50 is scored in lines 62 to form a rectangle. The scoring weakens and permits the easy removal of the area 64 within lines 62 to provide an opening for providing access to the standard two button ground fault interrupter. Thus, cover plate 50 can be used over any conventional recessed receptacle, either with or without ground fault interrupter. If there is no ground fault interrupter, the area 64 is left in place and lines 62 cannot be seen when cover plate 50 is in place. Alternatively, if a ground fault interrupter is present, area 64 is simply punched out prior to installation of cover plate 50. In either case, the exposed outer surface 52 of cover plate 50 can be provided with an aesthetically pleasing decorative surface. Preferably, the exposed outer surfaces 52 have a granite or tile finish in any desired color.

The cover plate 50 with prongs 60 is normally a single formed or molded plastic piece.

The finish provided on surfaces 28 and 52 is achieved most preferably by the known in-mold decorating process, using the film and resins available from General Electric Company.

FIG. 22 shows the arrangement whereby cover plate 10 of FIGS. 1 to 7 is held by screws 66 to electrical outlet 68. When assembled, electrical outlet 68 is received in receptacle box 70 which, in turn, is mounted in a recess in a wall. The electrical outlet has ground fault interrupter buttons 72 and 74. Buttons 72 and 74, when assembled with the rear of plate 10 abutting the front of outlet 68, are exposed at button receiving openings 18 and 20. The inserts 30 can be used if it is desired to conceal buttons 72 and 74.

The cover plates of this invention are adapted to be provided in the known Decora style designed to work with square receptacles and GFI receptacles.

1. An assembly for covering the receptacle head of a receptacle containing a wall-mounted, button-operated GFI electrical outlet, comprising
a cover plate having a front side and a rear side;
a plurality of blade apertures extending through the cover plate through the front and back surfaces and positioned in the cover plate so the blade apertures are in substantial alignment with the blade apertures of the at least one socket of said electrical outlet when the cover plate is affixed to the electrical outlet for receiving the plug blades; and
at least one securing aperture extending through the cover plate through the front and back surfaces and positioned in the cover plate so the at least one securing aperture is in substantial alignment with a corresponding one of the at least one securing aperture of the electrical outlet when the cover plate is affixed to the electrical outlet for receiving the securing device and fixedly positioning the cover plate with respect to the electrical outlet, the cover plate being sized to cover the receptacle when the securing device is in place, the cover plate having peripheral edges which are adapted to abut the wall surfaces surrounding said wall mounted receptacle containing a GFI electrical outlet;
the improvement wherein the cover plate has a pair of access openings to permit access to GFI buttons, said access openings being further adapted to be closed by inserts when GFI buttons are not present.

2. An assembly for covering the receptacle head of a receptacle containing a wall-mounted, button operated GFI electrical outlet, comprising:
a cover plate having a front side and a rear side;
a plurality of non-electrically conductive prongs, mounted to and extending perpendicularly from the rear side of the cover plate sized and spaced to engage the blade receiving apertures of the electrical outlet;
the cover plate being sized to cover the receptacle when the prongs engage the blade receiving apertures of the electrical outlet; the cover plate having peripheral edges which are adapted to abut the wall surfaces surrounding said wall mounted GFI electrical outlet;
the improvement wherein said cover plate is scored on its rear surface to provide a weakened line defining a closed area which is adapted to be broken out and removed to provide access to the GFI buttons.

3. The assembly of claim 1 in combination with a recessed receptacle containing a wall mounted, button operated GFI electrical outlet.

4. The assembly of claim 2 in combination with a recessed receptacle containing a wall mounted button operated GFI electrical outlet.
